(19) United States
(12) Patent Application Publication
(10) Pub. No.: US 2018/0024848 A1
(43) Pub. Date: Jan. 25, 2018

(54) Translatable Texts Identification in In-Context Localization Utilizing Pseudo-Language and an External Server

(71) Applicant: Crowdin, Inc., Wilmington, DE (US)

(72) Inventor: Serhiy Dmytryshyn, Ternopil' (UA)

(73) Assignee: Crowdin, Inc., Wilmington, DE (US)

(21) Appl. No.: 15/715,134

(22) Filed: Sep. 25, 2017

Related U.S. Application Data
(63) Continuation-in-part of application No. 15/650,966, filed on Jul. 16, 2017.
Application No. 15/650,966 is a continuation of application No. 14/557,432, filed on Dec. 1, 2014, now Pat. No. 9,804,862.
(60) Provisional application No. 61/910,959, filed on Dec. 2, 2013.

(51) Int. Cl. G06F 9/44

(52) U.S. Cl. CPC G06F 9/4448

(57) ABSTRACT

Software-as-a-service system and methods for assisting translators by utilizing in-context localization with a localization editor that permits the translator to easily view how their translations appear on the application interface in real-time without having to navigate between different screens (e.g. between the translation input interface, and the screen that displays how it will appear to the viewer). Pseudo-language that comprises extra language with special identifiers is added to a localizable application in place of the original text. The pseudo-language is identified in the runtime, after which it is mapped and replaced with the original text or their translations. An external server is used to generate the pseudo-language based on source texts, and to do the matching by communicating with the application being translated while it is being run with the activated pseudo-language. The translated software comprises a web-based application, content websites and non-web related software, e.g. mobile applications, desktop software.

### CROSS-REFERENCE TO RELATED APPLICATIONS

This application is a continuation-in-part of U.S. Utility patent application Ser. No. 15/650,966 filed on Jul. 16, 2017, which is a continuation of U.S. Utility patent application Ser. No. 14/557,432 filed Dec. 1, 2014, which claims the benefit of U.S. Provisional Application 61/910,959, filed Dec. 2, 2013, the entirety which are all herein incorporated by reference in their entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present disclosure is generally directed to a software-as-a-service web-based language translation service to facilitate translating web based applications, content websites and non-web related software such as mobile applications, desktop software, etc.

### BACKGROUND OF THE INVENTION

“In context translation and localization” of software applications produces a much higher quality of text translation as compared to more classic approaches—such as when translators work only on lists of texts without seeing the original usage of the text. The various embodiments of the present disclosure relate to improved methods of “in context localization” of software by human translators, wherein the software may be produced and hosted by third parties at remote locations from the translators. The software may be, for example, web based applications, content websites and non-web related software.

Most common software localization approaches currently utilize the extraction of translatable texts from application source code, putting the texts to the resource file, and translation of the texts making copies of the resource file. Translated resource files are included in the application in the runtime, thus making its user interface available in different languages.

From the methodology perspective, this approach provides good flexibility; however, it requires additional efforts of quality control since resource files are being translated with lack of context. This method makes the overall localization process expensive and error prone.

The prior art does disclose some attempts at “In Context Localization”. For example, United States Patent Application 20100107114 filed Oct. 28, 2008 by Slawomir Zachial describes how in context localization helps translators do high quality localization. However, the disclosed method is specific to web applications and it does not display the exact approach of how to get the solution accomplished by the end user. As a result, it is not usable for many technologies and development approaches. For example, it cannot be used to localize in-context non-web based applications, such as Android and iOS applications.

### SUMMARY OF THE DISCLOSURE

The various embodiments of the present disclosure provide a tool and online service to assist translators (e.g. professional and/or crowd-sourced volunteers) in efficiently and accurately translating the text displayed on a computer graphical user interface in web-based and non-web-based applications. The translator is able to view their translations as they will appear within the application without having to navigate between different screens (e.g. between where they input the translation, and the screen that displays how it will appear to the viewer).

The various embodiments herein provide solutions that allow computer systems to localize software in runtime, thus providing maximum contextual information to the translator. The software may comprise, for example, web based applications, content websites and non-web related software, such as mobile applications, desktop software, etc. The present disclosure enables an application to be translatable while it is being executed by identifying what part of the application is translatable, with the lowest entrance threshold for the end user, via the injection of pseudo-language and via the utilization of an external translation server for processes coordination (i.e. pseudo-language is used with an integration library).

The various embodiments assist translators by utilizing in-context localization. Pseudo-language, that comprises extra language with special identifiers, is added to a localizable application in place of the original text. The pseudo-language is identified in the runtime, after which it is mapped and replaced with the original text or their translations. An external server is used to generate the pseudo-language based on source texts, and to do the matching by communicating with the application being translated while it is being run with the activated pseudo-language.

In the various embodiments, the present invention(s) may comprise a computerized computer apparatus (e.g. end user device), system, method, and computer-usable medium having computer-readable program code stored thereon for causing the computer system to perform in-context localization to identify what is localizable.

A network-based computing system for one or more embodiments disclosed herein for in-context localization that allows a translator to view current translations in an application in real-time, comprises the following computer systems and components: a translation server; an application server; at least one end-user and a translator electronic computer device; and a wired or wireless network.

The translation server, the application server, end-user electronic computing device, and the translator electronic computing device, each comprise: a processor and a memory device operably connected to one another, and a plurality of computer-executable instructions stored on said memory device and executed by said processor.

On the translation server, the computer-executable instructions convert a plurality of source texts with pseudo-language texts. This requires the formation of pseudo-language by an external server (e.g. translation server) or another computing device in a manner that an application can display this pseudo-language text in the interface by: separating a portion of text to be translated and saving all of its variables in a pseudo-language that can be replaced during execution of an application; identifying plural forms of a string; and adding a specific string identifier that matches to the identifier on the electronic computing device that stores the original source strings.

And the database on the translation server stores records comprising: the source texts, internal identifiers, pseudo-language variants of the source texts, and a translation of the source text.

On application server, when the application is web-based software, the application server stores the data and the computer-executable instructions of the application being translated, and the localization resources that the application uses. And when the application is non-web-based, the application server stores the application's computer executable instructions and the localization resources being compiled to re-produce the application on the end-user or the translator electronic computing device. And, the application server and the translation server synchronize the source texts of the application and their translations when an integration is configured.

The end-user electronic computing device can be used by a developer of the application to set up the integration between the translation server and the application server, and/or to perform the synchronization of the source strings and their translations manually.

The translator electronic computing device performs a data processing method comprising the following computer steps of on: 1) replacing in response to the translator device running of the application, the pseudo-language identifiers with the text in the first language and making the text user-selectable; 2) launching a translation editor in response to the translator selecting the text, the editor comprising a view of the original string, the ability to receive manual input for correcting the translation, and the ability to allow the translator to preview and save the translation to the translation server; 3) displaying by the editor the corrected translation in the interface of the application; and 4) saving the corrected translation to the translation server.

Another data processing method of one or more embodiments of the present disclosure, comprises a translation method of an application that can be implemented via an application plugin and/or an additional library, and that runs on the translator electronic computing device, to execute one or more of the following computer steps:
a. reading pseudo-language and saving obtained details about each string in a memory of a translator electronic computing device, wherein the string details comprise the identifier on a server and a list of variables;
b. communicating with a server to retrieve at least one source string and its current partial translation;
c. replacing the source strings in pseudo-language with their original versions, or with existing translations, and modifications of the strings that occurred during execution of the application;
d. providing an option to select strings by the translator in order to enter new translations;
e. displaying a translation editor within the application interface in response to the string's selection;
f. displaying a preview of a translation while the translator enters a text without re-execution of the code of an application that led the string being shown in the interface; and
g. storing entered translations on an external server.

Furthermore, the additional software library that is for contextual translations and the external server that is for storing strings and translations, are both part of a platform that operates in software-as-a-service distribution model.

In another embodiment, the invention comprises a computer system(s), a computer method, and non-transitory code for the formation of pseudo-language by an external server or another computing device in a manner that an application can display this pseudo-language text in the interface by: separating a portion of text to be translated and saving all of its variables in a pseudo-language that can be replaced during execution of an application; identifying plural forms of a string; and adding a specific string identifier that matches to the identifier on the electronic computing device that stores the original source strings.

In another embodiment, the invention comprises a computer system(s), a computer method, and non-transitory code for an in-context localization for websites, web applications, desktop and mobile apps, and non-web-based applications comprising Android and iOS applications. The in-context localization allows a translator to view current translations in the application in real-time, without re-execution of the code of an application that led the string being shown in the interface. This method includes: storing source strings within a memory of the external translation server; and replacing by an external translation server source strings that has to be translated from a first language to a second language for pseudo-language texts. The pseudo-language texts comprise a sequence of characters that allows the computer(s) to map pseudo-language texts with the source strings on the translation server, and allows the application to display pseudo-language texts as regular source texts, making changes to the displayed strings during the running of an application (typical example of such string changes: “Hello {name}”->“Hello John”).

The method further comprises: an application mode on a translator's computing device that makes pseudo-language texts readable and allows translator to select a text for translation; and a translation editor that is shown in response to selecting the string by a translator, which communicates with an external server to get the original strings. The editor comprises a graphical user interface that allows translator to view the original string, input a translation, and have an instant preview of the translation in live application. And the method further comprises: storing the translated versions of the strings within a memory of the external translation server; and integration of translated versions of the strings into the application.

The integration of a pseudo-language occurs without modifying the source code of an application, by adding the additional target language with which an application usually works.

And the method further comprises a mechanism of replacing pseudo-language texts with ones in a source or other language(s), displaying on an interface for translation, previewing of the source strings, and saving the translations being implemented outside of the application that is being localized.

Th pseudo-language is generated by the remote translation server, then transmitted to and stored on the translator's electronic computing device co-located with an application that is being localized. And the translation mode implies another instance of an application co-located with the main one.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

In one or more embodiments, the system employs a software-as-a-service architecture, which permits multiple end-user computing devices to simultaneously access the system software on the remote translation server for converting text strings to pseudo-language identifiers.

These and other features of the present invention will be presented in more detail in the following specification of certain embodiments of the invention and the accompanying figures which illustrate by way of example the principles of the invention.

### BRIEF DESCRIPTION OF THE DRAWINGS

The present invention will now be further described through various embodiments in reference to the accompanying drawings comprising:

FIG. 1 depicts a block diagram of the system architecture for in-context localization of an application in accordance with one or more embodiments.

FIG. 2 depicts a block diagram of an end user's and/or a translator's electronic computing device used for in-context localization in accordance with one or more embodiments.

FIG. 3 is a Unified Modeling Language (UML) sequence diagram of the primary method for in-context localization of the web-based application.

FIG. 4 is an illustration of an application interface with an example string displayed, and how this string appears in the original resource file and after being converted to a pseudo-language.

FIG. 5 is a before and after illustration of an application interface, showing the process of converting pseudo-language texts integrated earlier by the external library to source language texts and making the texts clickable.

FIG. 6 is an illustration of the translation editor that permits the translator to view his translation in-context in real-time, and to manually edit it if required.

FIG. 7 is similar to FIG. 4 and depicts the example of a more complex source string usage in ICU (International Components for Unicode) syntax.

### DETAILED DESCRIPTION OF EXEMPLARY EMBODIMENTS

Reference will now be made in detail to specific embodiments of the invention. Examples of these embodiments are illustrated in the accompanying drawings. While the invention will be described in conjunction with specific embodiments, it will be understood that it is not intended to limit the invention to these embodiments. On the contrary, the invention is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Unless defined otherwise, all technical and scientific terms used herein have the same meanings as commonly understood by one of ordinary skill in the art to which the invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

As used herein, a “computer” refers to one or more apparatus and/or one or more systems that are capable of accepting a structured input, processing the structured input according to prescribed rules, and producing results of the processing as output. Examples of a computer may include: a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet computer, a personal digital assistant (PDA), a portable or mobile telephone or other mobile computing device; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; and generally, an apparatus that may accept data, process data according to one or more stored software programs, generate results, and typically include input, output, storage, arithmetic, logic, and control units.

As used herein, a “computer system” may refer to a system having one or more computers, where each computer may include computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

As used herein, the term “processor” may refer to any device or portion of a device or apparatus that processes electronic data from registers and/or memory to transform that electronic data into other electronic data that may be stored in registers and/or memory. A “computer system” may comprise one or more processors.

As used herein, the term “computer-readable medium” refers to any medium that participates in providing data (for example, instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

As used herein, the term “Application” and “Software” refer to all, or a portion, of a computer program or software code that carries out a specific function and may be used alone or combined with other programs, such as: web based applications, content websites and non-web related software, e.g. mobile applications, desktop software, etc. Examples of software code in applications may include: code segments in one or more computer-readable languages; graphical and or/textual instructions; applets; pre-compiled code; interpreted code; compiled code; and computer programs. Computer program code for carrying out operations for aspects of the various embodiments may be written in any combination of one or more programming languages, such as: an object oriented programming languages and/or conventional procedural programming languages, and/or programming languages such as, for example, Hypertext Markup Language (HTML), Dynamic HTML, HTML5, Extensible Markup Language (XML), Extensible Style sheet Language (XSL), Document Style Semantics and Specification Language (DSSSL), Cascading Style Sheets (CSS), Synchronized Multimedia Integration Language (SMIL), Wireless Markup Language (WML), JAVA; JavaScript., JINI, C, C++, Objective C or any language operable on a wireless platform like iOS, Ruby, Ruby on Rails, Perl, UNIX Shell, Visual Basic or Visual Basic Script, Virtual Reality Markup Language (VRML), ColdFusion™; Adobe Flash & related languages; or other compilers, assemblers, interpreters or other computer languages or platforms.

As used herein, the term “Application Interface” refers to the space where interactions between user and computer program occur. Usually it's a set of data, buttons and other control elements displayed on the screen of user's electronic computing device.

As used herein, the term “End-user” refers to the software developer that utilizes the in-context localization method in the various embodiments. The term may also refer to website owners, application publishers, content mangers, and the like.

As used herein, the term “Electronic Computing Device” refers to an end-user's and translator's computer with network connectivity (e.g. Internet) and with a user interface to view and interact with the application interface, such as a laptop, desktop, tablet, etc., as well as the list of “computers”.

As used herein, the term “Translation Server” refers to the computer system server associated with the end-user and/or translator. It may be co-located or remote from the end-user and/or translator and accessible via the network (e.g. Internet), such as a web-based business providing a service to assist translators in localizing end-user software. For example, a project manager may communicate with a translator via the translation server using comments/issues system, a tasks management system, or via any other network based method that they prefer. It may store localization resources and translations.

As used herein, the term “Localization Resources” refers to the file or set of the files (or database records) that contains the documents, texts and assets (images, audio tracks, video) that need to be localized (i.e. translated and available to be integrated into the application in order to make the application multilingual).

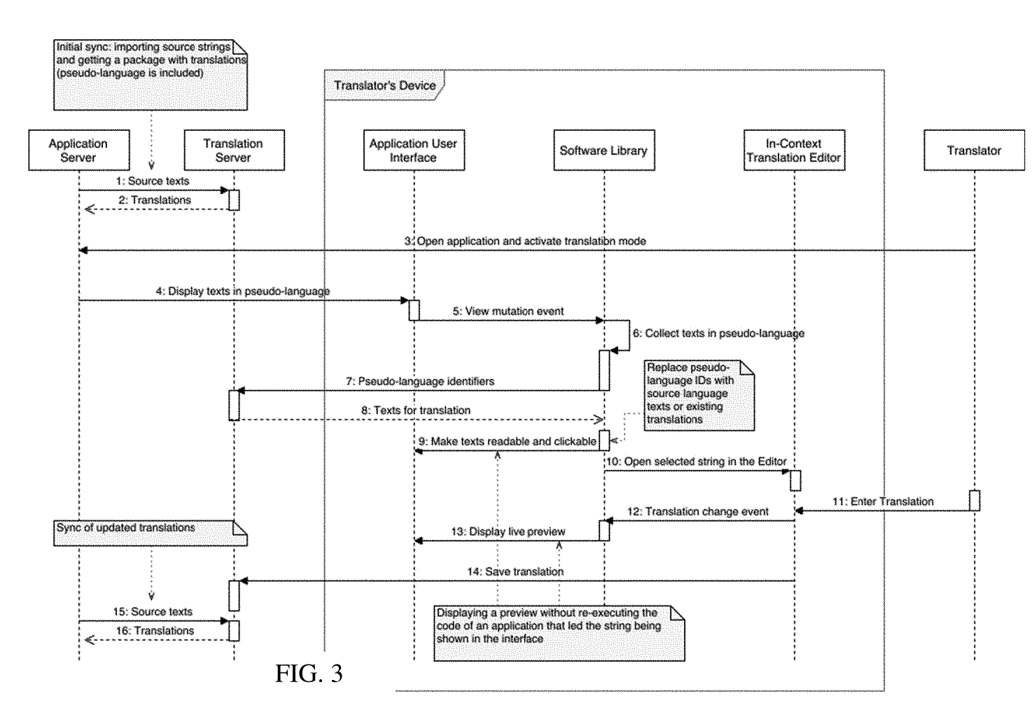

As used herein, the term “Application Server” refers to the computer system server associated with the end-user. In case of the web-based software (FIG. 3), it is used for processing requests from users via network, and serving web-pages of files. It stores the data and the code of the application which is being executed on the server, and localization resources that application uses. Alternatively, in non-web related software, application server can store the code and localization resources that are being compiled to get a stand-alone version of the application.

### System Architecture

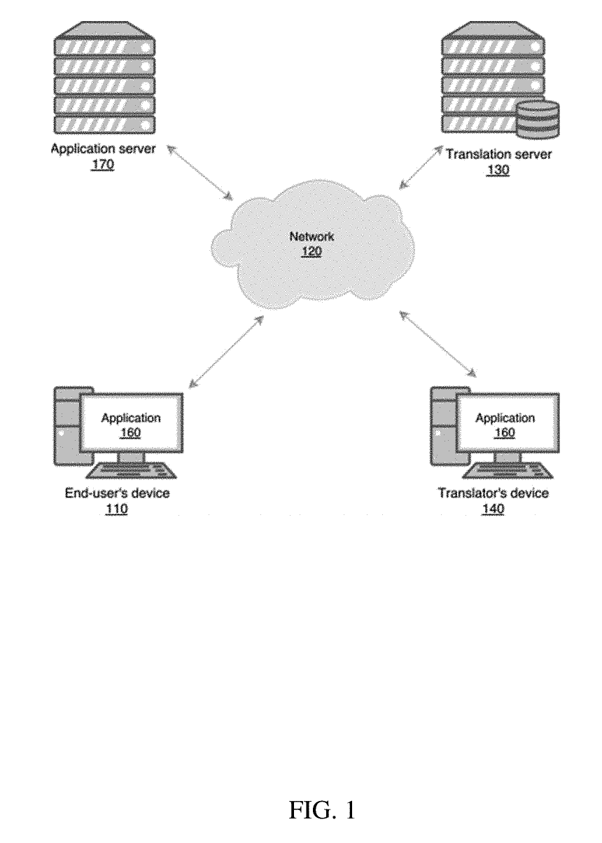

Embodiments of the presently disclosed subject matter may be implemented in and used with a variety of components and network architectures. In one or more embodiments, the system may comprise a Service-as-a-Software (SaaS) platform. As illustrated in FIG. 1, the system of the various embodiments may comprise, for example: one or more end-user electronic computing devices 110 communicating via a network 120 (e.g. the Internet) with a translation server 130. The system may further comprise one or more translator's electronic computing devices 140 in communication with the translation server 130 via the network 120. The end-user electronic computing devices 110 and the translator electronic computing devices 140 may also communicate directly via the network 120, and/or with remote servers, databases, cloud computing services and the like. The system may also comprise a separate application server 170 storing the end-user application 160 (e.g. cloud computing), or the application 160 may be stored on the end-user's electronic computing device 110.

In one or more embodiments, the translation server 130 represents a web-based entity providing services to translators, and may further comprise one or more central processing units, memory storing computer code for the generation of pseudo-language identifiers, records of subscribers to the web-based service (e.g. translators and translation companies), network interfaces, etc.

The Network 120 may be a local network, wide-area network, the Internet, or any other suitable communication network or networks, and may be implemented on any suitable platform including wired and/or wireless networks. The electronic computing devices 110 and 140 may connect to the network 120 via a variety of methods such as a phone modem, wireless (cellular, satellite, microwave, infrared, radio, etc.) network, Local Area Network (LAN), Wide Area Network (WAN), or any such means as necessary to communicate with the translation server 130.

The network may also comprise various types of computer system configurations, including personal computers, hand-held devices, multi-processor systems, microprocessor-based or programmable consumer electronics, network PCs, minicomputers, mainframe computers, and the like. Where appropriate, embodiments may also be practiced in data centers, cloud computing environments, Software-as-a Service (SaaS) environments, or other distributed computing environments where tasks are performed by local and remote processing devices that are linked (either by hardwired links, wireless links, or by a combination thereof) through a communications network. In a distributed computing environment, program modules may be located in both local and remote memory storage devices.

Various embodiments of the presently disclosed subject matter may include or be embodied in the form of computer-implemented methods or processes and apparatuses for practicing those methods or processes; and/or, in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer (e.g. device 110, 130, 140, and/or 170), the computer becomes an apparatus for practicing embodiments of the disclosed subject matter.

The various embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer (e.g. device 110, 130, 140, and/or 170), the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Lastly, the various embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

### End User's and Translator's Computing Device

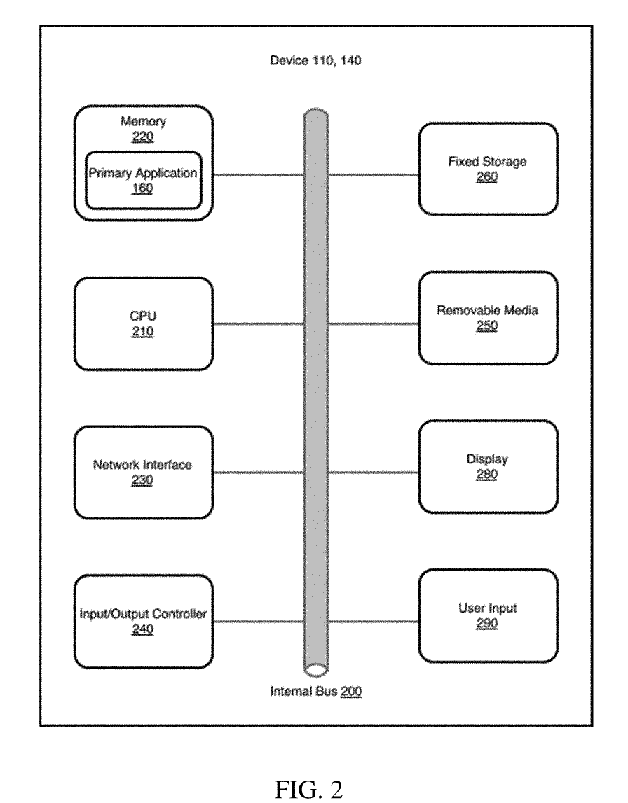

As illustrated in FIG. 2, the end-user's electronic computing device 110, and/or translator's electronic computing device 140 comprises an internal bus 200 connecting the major components of each device to its central processing unit (i.e. processor or microprocessor) 210 and memory 220. Devices 110, 140 have the ability to transmit and receive electronic communications via a network interface 230 which allows the devices and servers to communicate with each other via one or more local, wide-area, or other networks. Furthermore, devices 110 and 140 may comprise any one of the following operating systems (OS), for example: Android, Windows, macOS or Apple iOS, such as in smartphones, tablets, laptops, desktops, etc.

The network interface 230 may provide a direct connection to a remote server (e.g. Application Server 170 and/or Translation Server 130) via a telephone link, to the Internet via an internet service provider (ISP), or a direct connection to a remote server via a direct network link to the Internet via a POP (point of presence) or other technique. The network interface 230 may connect the computers using wireless techniques, including digital cellular telephone connection, Cellular Digital Packet Data (CDPD) connection, digital satellite data connection or the like.

Memory 220 comprises read-only memory (ROM) or flash memory containing Basic Input-Output system (BIOS) controlling basic hardware operation including interaction with peripheral components. Memory 220 further comprises random access memory (RAM) comprising the main memory into which the device's operating system (e.g. Android or Windows or Apple), and application programs (e.g. Primary Application 160) are loaded. The application programs can be stored on and accessed via a non-transitory computer readable medium, such as a hard disk drive (e.g., fixed storage 260), an optical drive, floppy disk, or other storage medium.

Bus 200 further connects an input/output controller 240, a user display 280, such as a display screen via a display adapter, a user input interface 290, which may include one or more controllers and associated user input devices such as a keyboard, mouse, touchscreen and the like, a fixed storage 260 (such as a hard drive, flash storage, Fiber Channel network, SAN device, SCSI device, and the like), and a removable media component 250 operative to control and receive an optical disk, flash drive, and the like. The fixed storage 260 may be integral with the device 110, 140 (and 130, 170) or it may be separate and accessed through other interfaces. Computer program code to implement the various embodiments can be stored in computer-readable storage media, such as one or more of the memory 220, fixed storage 260, removable media 250, or on a remote storage location.

The user input interface 290 enables a user to enter data and/or instructions to the device 110, 140 (and 130, 170) through one or more corresponding input devices, such as an image scanner w/ camera, a touch screen, a keyboard, a mouse, a trackball, a light pen, stylus, or other pointing device, a microphone, a joystick, a game pad, a satellite dish, a scanner, a camcorder, a digital camera, and the like. Similarly, examples of input interfaces 290 that may be used to connect the input devices to the bus 200 include: a serial port, a parallel port, a game port, a universal serial bus (“USB”), a firewire (IEEE 1394), or another interface. Lastly, output interfaces connect one or more corresponding output devices to the bus 200, such as a monitor or display screen 280, a speaker, a printer, and the like. An output device can integrate with or be peripheral to a device, such as: a video adapter, an audio adapter, a parallel port, and the like.

### Data Processing Method

One exemplary embodiment of the present invention is illustrated in the unified modeling language (UML) diagram shown in FIG. 3.

This diagram assumes that the web-based application 160 is already prepared for localization, and translatable texts were identified and collected by the software developer or any automatic solution. Also, application 160 is ready to display texts in different languages based on the application user's choice by using localization resource files or other storage for texts.

In FIG. 3, steps 1 and 2 describe the process of translatable texts transmission from the application server 170 via the network 120 to the translation server 130. It may be done manually by the software developer, or automatically, if the appropriate integration was configured earlier. After that, translations for the languages chosen by software developer are transmitted back, stored on the application server 170 and are ready to be used by the application 160. Pseudo-language needed for in-context localization is also included.

In the exemplary embodiment disclosed herein, pseudo-language stored in the resource file for each string includes: unique string identifier, plural form of the string, list of variables used in the original source sting, for example:

reserved-word|identifier:plural-form|variables-list|reserved-word

The “reserved-word” presents certain sequence of characters that allows the program to identify that the string belongs to the pseudo-language (for example “crwdns”); the “identifier” presents the string identifier at translation server 130 or in the resource file where it was imported from; and, the “plural-form” indicates that the string has plural forms and what form is being used in the particular case.

In step 3, the translator's computing device 140 accesses and opens the primary application 160 via the network 120, in case it is a web-based software or website content being translated. If text of non-web related software is being translated, such as on mobile applications, desktop software, etc., the translator's computing device 140 opens the application 160 stored in the memory of translator's device 140. Both types of applications further comprise the software library (from the translation web-service provider) that will communicate via the network with the translation server 130.

Translation mode activation can be applied by accessing a separate version of the application 160, switching its language or in another way. In any case, the translation mode implies that translatable texts are being displayed as a pseudo-language and the additional software library (from the translation web-service provider) is activated.

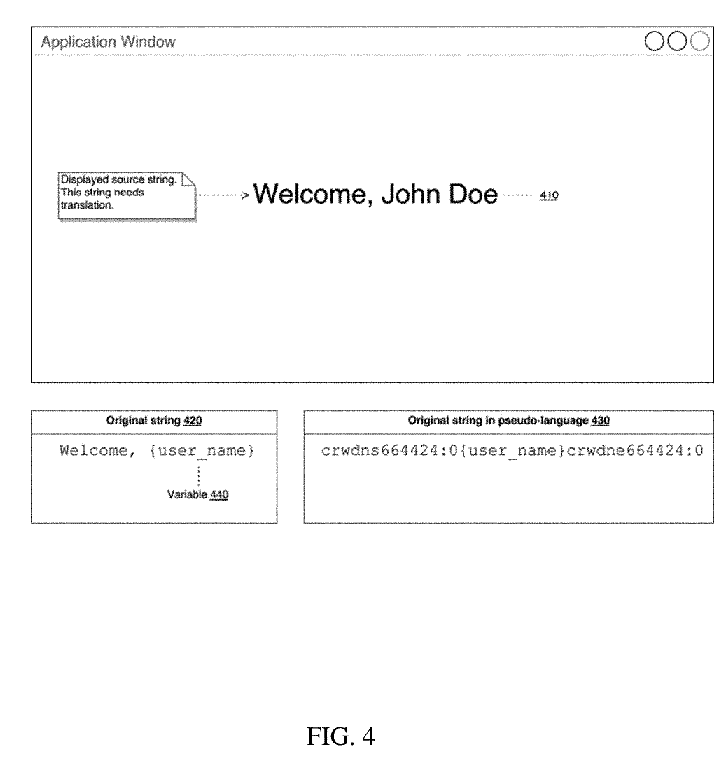

In step 4, the application interface is displayed. By default, when translation mode is disabled, application user views the interface in the original app language (e.g. see FIG. 4). If the original string has any variables, during the execution of the app they will be replaced by their values. With translation mode enabled, all translatable texts will be displayed as a pseudo-language.

In steps 6, 7, 8, the software library, which is launched along with the application 160, in response to view mutation (step 5), goes through the application user interface (or traverse web application DOM) identifying pseudo-language texts that are displayed instead of the actual text messages. Then it communicates with translation server 130 and receives the original source strings with all their metadata, according to identifiers, collected from pseudo-language texts.

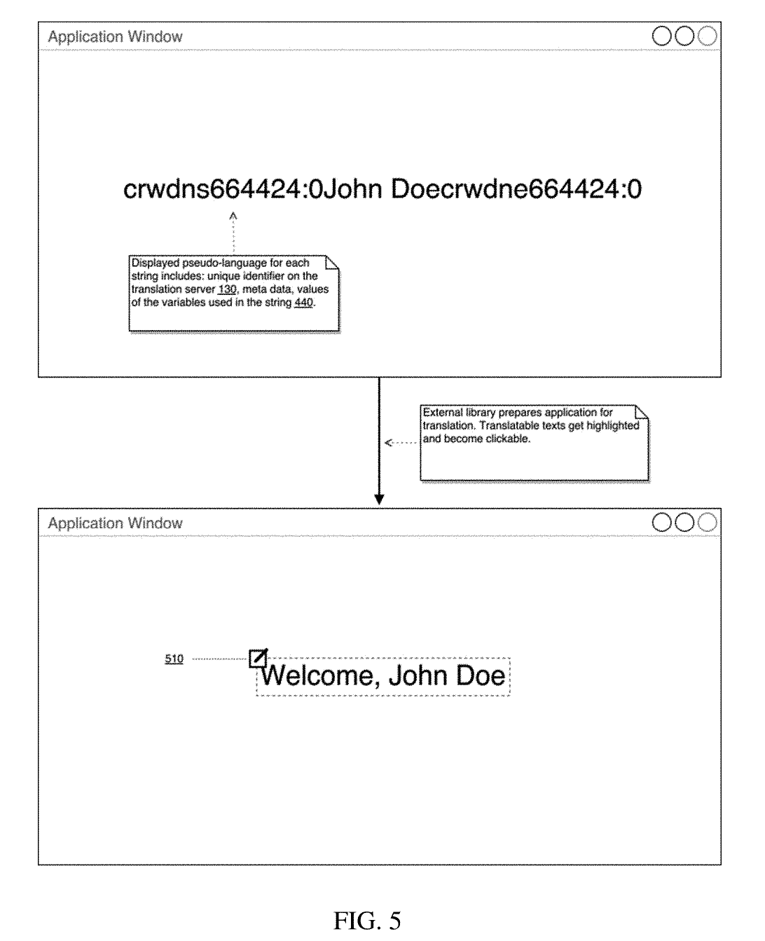

In step 9, the pseudo-language strings on the translator's application interface are replaced to actual text messages that become clickable (software library adds additional event handlers to the replaced texts) for the purpose of opening a translation editor (FIG. 5). This replacement is done with the help of the software library and without re-execution of the code of an application that led the string being shown in the interface. Values of the variables used in the string are preserved during the replacement. The replacement can be done during the application launch or later while the application is operable (for translatable text messages that appear dynamically). Instead of source string text, its translation for the selected language can be shown if it exists.

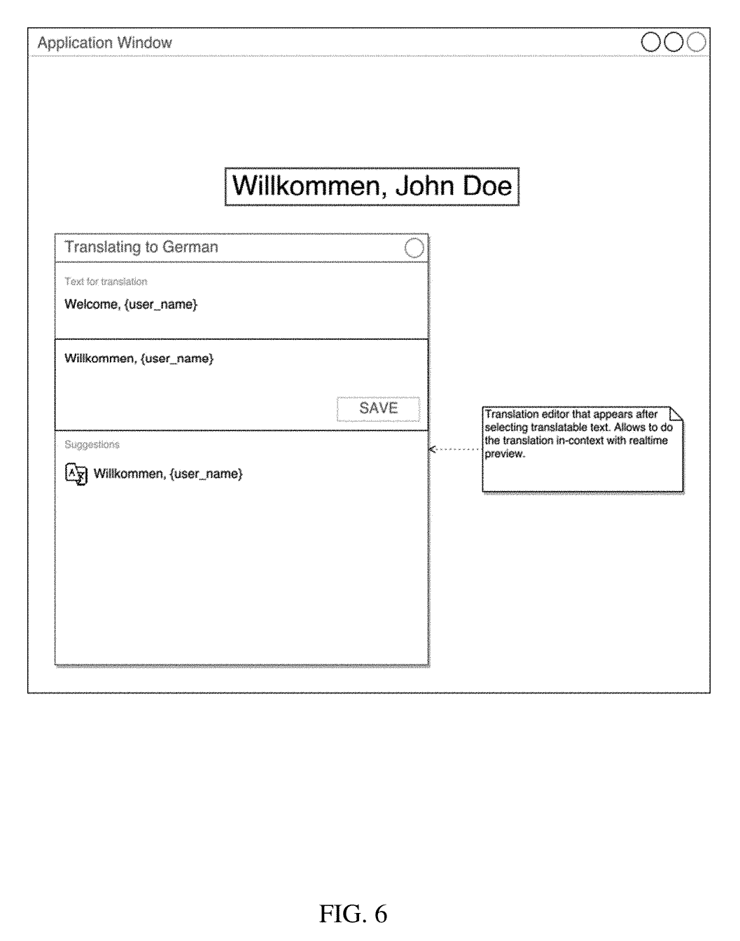

In step 10, in response to the translator's clicking, touching, tapping, etc. on the text (e.g. the “Login” tab), the integrated software library opens an additional dialog box in the user interface (or separate window), otherwise known as the “ translation editor” (e.g. see FIG. 6). The translation editor allows the translator to enter the translation of the text manually (step 11).

Every time the translator changes the translation, the integrated software library applies this translation on the page and preserves actual values of the variables that are used in the string (step 13). This replacement process is similar to those for pseudo-language texts in step 9.

When the translation is ready, in response to the translator's command, the translation editor saves this translation to the translation server 130 (step 14) that makes it available for other translators to view.

Updated translations can be used by application 160 as final ones by syncing translations between translation server 130 and application server 170 (steps 15 and 16). This process is similar to those in steps 1 and 2.

### Exemplification of the Pseudo-Language Generation

The following is an exemplification to demonstrate the steps of FIG. 3 pertaining to pseudo-language generation of end-user selected texts. For example, there is a string in the resource file:

ProfileScreen.WelcomeMessage=“Welcome, {user_name}”

“ProfileScreen.WelcomeMessage” is the text identifier that is used by the application to display the text message. “Welcome, {user_name}” is the text. After uploading to the translation server and pseudo-language generation, the returned resource file string may look like the following:

PageContacts.Subject=“crwdns664424:0{user name}crwdne664424:0”

The pseudo-language contains needed information to have this string identified on the application page in order to make it available for translation and to provide live in-context preview. The structure of that sample pseudo-translation is, as stated supra, the following:

reserved-word|identifier:plural-form|variables-list|reserved-word

### Exemplification of Webpage In-Context Localization

The following exemplification comprises the sequence of steps and mockup views the translator sees on the application interface as illustrated in FIGS. 4-6. In this exemplary embodiment, texts of the “Welcome” page are translated via the method of the present invention.

FIG. 4 is an illustration of an application interface with the “Welcome” message 410 being displayed in source language with the translation mode turned off. Also, it shows how this string looks like in the original resource file (420) with the “user name” variable (440) before modifications are made during execution of an application 160. Also, the example of this string converted to a pseudo-language (430) is shown as well. The translator translates the string as it is stored in the resource file (420).

FIG. 5 is a mockup of the application interface as viewed on the translator's computing device 140, and comprising FIG. 3 steps 4-9 for the primary application 160, converting the pseudo-language unique identifiers to the source language texts and making the texts readable and clickable. For example, the translatable text “Welcome, John Doe” is now highlighted and clickable (see FIG. 5, 510).

FIG. 6 is an illustration of the application interface comprising the translation editor that is displayed on the translator's device 140 in response to selecting (clicking on, tapping on) translatable text (e.g. FIG. 5, 510), as per FIG. 3, step 10. The editor allows the translator to view the machine translations of the selected text, to use them, or to manually input their own translations of the text. Instant preview with the live application data enables the translator to view more efficiently how each manually made input is displayed on the application interface, and to easily correct it in order to make it fit to the UI.

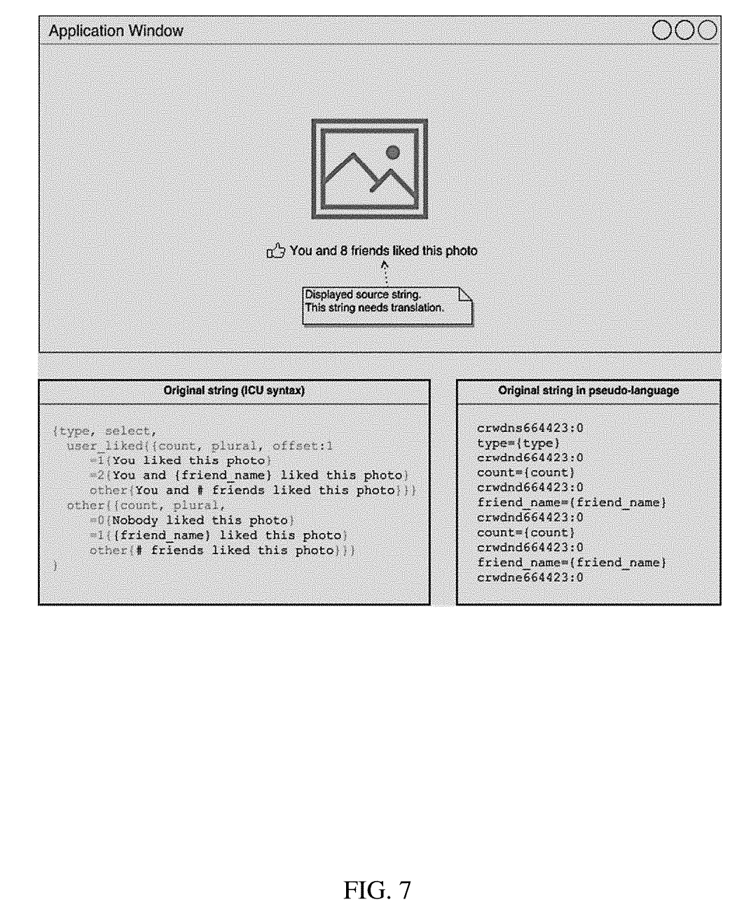

FIG. 7 is similar to FIG. 4 and depicts an example of a more complex source string usage. The localization method in the present invention is also suitable for providing real-time preview during in-context translation of the strings with multiple variables and ICU syntax. The message “You and 8 friends liked this photo” may be displayed on page in different ways, e.g. “Nobody liked this photo” if variable “ {count} ” would have 0 as a value during execution of the application 160.

### CONCLUSION

The aforementioned UML diagram illustrates the architecture, functionality, and operation of possible implementations of systems, methods, and apparatuses comprising computer program products (aka computer code) and/or computer-usable medium having computer-readable program code stored thereon according to various embodiments of the present invention. In this regard, a step(s) in the UML diagrams may represent a module, segment, or portion of code, which comprises one or more executable instructions for implementing the specified logical function(s). It should also be noted that, in some alternative implementations, the functions noted in the diagrams may occur out of the order noted in the figures. For example, steps shown in succession may, in fact, be executed substantially concurrently, or the steps may sometimes be executed in the reverse order, depending upon the functionality involved. It will also be noted that each step of the UML diagram, and combinations of steps, can be implemented by special purpose hardware-based systems that perform the specified functions or acts, or combinations of special purpose hardware and computer instructions.

And, in the above description, an embodiment is an example or implementation of the inventions. The various appearances of “one embodiment,” “an embodiment” or “some embodiments” do not necessarily all refer to the same embodiments.

Unless specifically stated otherwise, and as may be apparent from the description and claims herein, terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The various embodiments may also be implemented in an operating environment comprising computer-executable instructions (for example, software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages.

What is claimed is:

1. A network-based computing system for in-context localization allowing a translator to view current translations in an application in real-time, comprising:
a. a translation server comprising a processor and a memory device operably connected to one another, and a plurality of computer-executable instructions stored on said memory device and executed by said processor, comprising:
i. a computer-executable instructions to convert a plurality of source texts with pseudo-language texts;
ii. a database storing records comprising, the source texts, internal identifiers, pseudo-language variants of the source texts, and a translation of the source texts;
b. an application server comprising a processor and a memory device operably connected to one another, and a plurality of computer-executable instructions stored on said memory device and executed by said processor;
c. an end-user electronic computing device that can be used by a developer of the application, and to set up the integration between the translation server and the application server, and/or to perform the synchronization of the source strings and their translations manually;
d. a translator electronic computing device comprising a processor and a memory operably connected to one another, and a plurality of computer-executable instructions stored on said memory device and executed by said processor, comprising a computer-executable instructions for:
i. replacing in response to the translator running the application, the pseudo-language identifiers with the text in the first language and making the text user-selectable;
ii. launching a translation editor in response to the translator selecting the text, the editor comprising a view of the original string, the ability to receive manual input for correcting the translation, and to allow the translator to preview and save the translation to the translation server;
iii. displaying the corrected translation in the interface of the application;
iv. saving the corrected translation to the translation server; and
e. a wired or wireless network connection between the application server, the translation server, the one or more end-user and translator electronic computing devices.

2. The network-based computer system of claim 1, wherein when the application is web-based software, the application server stores the data and the computer-executable instructions of the application being translated, and the localization resources that the application uses.

3. The network-based computer system of claim 1, wherein when the application is non-web-based, the application server stores the application's computer executable instructions and the localization resources being compiled to re-produce the application on the end-user or the translator electronic computing device.

4. The network-based computer system of claim 1, wherein the application server and the translation server synchronize the source texts of the application and their translations when the integration was configured.

5. The network-based computer system of claim 1, wherein a formation of pseudo-language to display the pseudo-language text in the interface comprises,
separating a portion of text to be translated and saving all of its variables in a pseudo-language that can be replaced during execution of an application;
identifying plural forms of a string; and
adding a specific string identifier that matches to the identifier on the electronic computing device that stores the original source strings.

6. An application translation computer method implemented via an application plugin and/or a library that runs on the translator electronic computing device, comprising:
a. reading pseudo-language and saving obtained details about each string in a memory of a translator electronic computing device, wherein the string details comprise the identifier on a server and a list of variables;
b. communicating with a server to get at least one source string and its current partial translation;
c. replacing the source strings in pseudo-language with their original versions, or with existing translations, and modifications of the strings that occurred during execution of the application;
d. providing an option to select strings by the translator in order to enter new translations;
e. displaying a translation editor within the application interface in response to the string's selection;
f. displaying a preview of a translation while the translator enters a text without re-execution of the code of an application that led the string being shown in the interface; and
g. storing entered translations on an external server.

7. The application translation method of claim 6, wherein the additional software library is for contextual translations and the external server is for storing strings and translations, and wherein the library and external server are part of a platform that operates in software-as-a-service distribution model.

8. A data processing method of an in-context localization for allowing a translator to view a current translation in an application in real-time, without re-execution of the application computer code that led a string being shown in a graphical user interface, comprising,
a. storing a source strings within a memory of an external translation server;
b. replacing by the external translation server source strings that were translated from a first language to a second language for pseudo-language texts, wherein the pseudo-language texts comprise a sequence of characters that allows a computer to map the pseudo-language texts with the source strings on the translation server, and allows the application to display pseudo-language texts as regular source texts, making changes to the displayed strings during the running of an application;
c. executing an application mode on a translator electronic computing device that makes the pseudo-language texts readable and allows the translator to select a text for translation;
d. executing a translation editor that is displayed in response to selecting the string by a translator, wherein the translation editor communicates with an external server to get the original strings;
e. storing the translated versions of the strings within a memory of the external translation server; and
f. integrating the translated versions of the strings into the application.

9. The data processing method of claim 8, further comprising integrating the pseudo-language of step 8(b) without modifying the source code of the application, and by adding the additional target language with which an application usually works.

10. The data processing method of claim 8, wherein replacing the pseudo-language texts with one is a source or other language(s), displaying on the interface for translation, previewing the sources strings, and saving the translations are implemented outside the application that is being localized.

11. The data processing method of claim 8, wherein the in-context localization is performable in web-based applications, websites, and non-web-based applications comprising Android and iOS applications.

12. The data processing method of claim 8, wherein the pseudo-language is generated by the remote translation server, then transmitted to and stored on the translator electronic computing device co-located with the application that is being localized.

13. The data processing method of claim 8, wherein a translation mode comprises another copy of the application co-located with the main one.

14. The data processing method of claim 8, wherein the editor comprises a graphical user interface that allows the translator to view the original string, input a translation, and instantly preview the translation in real-time.
